(19) United States
(12) Patent Application Publication
(10) Pub. No.: US 2009/0114078 A1
(43) Pub. Date: May 7, 2009

(54) Musical Button-Field Layout for Alphanumeric Keyboards

(76) Inventor: James Lee Plamondon, Austin, TX (US)

Correspondence Address: FOX ROTHSCHILD LLP, 2000 MARKET STREET, 10th Floor, PHILADELPHIA, PA, 19103, US

(21) Appl. No.: 11/815,958

(22) PCT Filed: Feb. 9, 2006
(86) PCT No.: PCT/AU06/00169

§ 371 Date: Sep. 9, 2008

(30) Foreign Application Priority Data
Feb. 9, 2005 (AU) 2005900592

(51) Int. Cl. G10C 3/12

(52) U.S. Cl. 84/423 R

(57) ABSTRACT

A computer keyboard including a plurality of buttons for use as an alphanumeric input device, wherein an interval-based isomorphic note layout is mapped to the buttons, and the keyboard is able to function as a music controller input device.

### FIELD OF THE INVENTION

The present invention relates to musical instruments and to electronic musical instruments in particular, and more particularly to the use of alphanumeric computer keyboards as music controller input devices.

### BACKGROUND OF THE INVENTION

### Definitions

A “note” is a specific pitch (e.g., C4), a member of a pitch-class (e.g., C), or a musical interval (e.g., Do in tonic solfa). Tonic solfa is also known as “moveable Do.” In tonic solfa, Do indicates a specific position within the cycle of intervals known as “the diatonic scale,” which is independent of any specific key or mode.

A note-controlling device or surface can be called a “button,” while a bounded two-dimensional array of at least three such buttons (not all in the same line) can be called a “button-field.” The specific spatial pattern of buttons within a button-field can be called its “button-arrangement” or simply “arrangement.” A regular two-dimensional pattern of musical notes can be called a “note-layout” or simply “layout.” Similarly, a pattern of association between a note-layout and a button-arrangement can be called a “mapping” of that layout to that arrangement. A musical instrument including at least one such button-field can be called a “button-field instrument,” just as a musical instrument including at least one piano-style keyboard is commonly called a “keyboard instrument.”

A button-field's arrangement can be “static” or “dynamic.” If the button-arrangement can be changed at the user's discretion it is dynamic, whereas if it is fixed at the time of manufacture then it is static.

Computers, Keyboards, and Music

As the power of microprocessors grows and their cost declines, many functions previously accomplished by special-purpose electronic circuitry are performed more cost-effectively in software by general-purpose computing devices such as desktop computers, laptop computers, game consoles, and Personal Digital Assistants (PDAs).

One such function previously accomplished primarily through special-purpose electronic circuitry is the synthesis of musical sounds. Software-based music notation, composition, and sound synthesis are increasingly capable and popular, especially among musicians who compose or at least notate their music on computers.

The familiar 88-key piano keyboard is well over a meter wide—far larger than a laptop computer's alphanumeric keyboard. Smaller piano-style “MIDI Controller” keyboards (known to those familiar with the art of electronic music), with only a few octaves of keys (48 keys or fewer) have sold well to computer-based musicians, showing that musicians are seeking a portable means of entering musical information into their computers.

Attempts have been made to map the familiar piano keyboard's pattern of keys to the familiar alphanumeric computer keyboard's button-arrangement. These efforts have not fared well because the piano keyboard is essentially one-dimensional (linear) whereas the computer's alphanumeric keyboard is two-dimensional. No mapping of the one-dimensional piano keyboard to the two-dimensional computer keyboard can overcome this fundamental mismatch.

Another attempt to combine the features of the alphanumeric keyboard and piano keyboard is Creative Labs' “Prodikeys” keyboard, which physically combines a standard piano-style keyboard with a standard alphanumeric keyboard (http://www.prodikeys.com/products/prodikeys). This combination occupies the physical space of both, and cannot be used for laptop computers' integrated keyboards.

It is therefore an object of the present invention to improve the alphanumeric computer keyboard as a musical input device.

### SUMMARY OF THE INVENTION

With the above object in mind the present invention includes a method for associating musical intervals with the relevant buttons of alphanumeric computer keyboards.

In one aspect the present invention provides a computer keyboard including a plurality of buttons for use as an alphanumeric input device, wherein a Wicki/Hayden layout of intervals is mapped to said buttons. This mapping will enable the keyboard to function as a music controller input device.

In a further aspect the present invention provides a system for mapping an isomorphic note layout, said layout including a plurality of notes wherein each said note is assigned to a respective at least one alphanumeric button of an alphanumeric keyboard, said keyboard forming a music controller input device such that operation of a said alphanumeric button is interpreted by a music controller that said note assigned to said alphanumeric button is to be generated, and wherein assigning of said plurality of notes to said respective at least one alphanumeric button maintains the isomorphic pattern of said note layout.

In a further aspect the present invention provides a system for mapping an interval-based isomorphic note layout to an alphanumeric keyboard, said layout including a plurality of notes, wherein each said note is assigned to a respective at least one alphanumeric button of said alphanumeric keyboard, said keyboard forming a music controller input device such that operation of a said alphanumeric button produces a signal that can be interpreted by a tone generator to indicate that said note assigned to said alphanumeric button is to be generated, and wherein assigning of said plurality of notes to said respective at least one alphanumeric button maintains the inter-button interval pattern of said isomorphic note-layout.

In another aspect the present invention provides a system for mapping a first and second note layout to an alphanumeric keyboard, said keyboard including a left button set and a right button set, said left and right button sets each including a plurality of alphanumeric keys, wherein said first note layout is mapped to said left button set, and said second note layout is mapped to said right button set;

said first and second note layouts each including a plurality of notes forming a respective isomorphic pattern;

wherein each said note of said first note layout is assigned to a respective said alphanumeric button of said left button set, wherein assigning of each said note of said first note layout to said respective alphanumeric button maintains the isomorphic pattern such that each adjacent note assigned to each respective said alphanumeric button of said left button set on said keyboard has a defined musical interval;

wherein each said note of said second note layout is assigned to a respective said alphanumeric button of said right button set, wherein assigning of each said note of said second note layout to said respective alphanumeric button maintains the isomorphic pattern such that each adjacent said note assigned to each respective said alphanumeric button on said right button set on said keyboard has a defined musical interval;

said keyboard forming a music controller input device such that operation of a said alphanumeric button is interpreted by a music controller that said note assigned to said alphanumeric button is to be generated.

In another aspect the present invention provides a system for mapping a first and second isomorphic note layout to an alphanumeric keyboard, said keyboard including a left button set and a right button set, said left and right button sets each including a plurality of alphanumeric keys, wherein said first note layout is mapped to said left button set, and said second note layout is mapped to said right button set;

wherein each said note of said first isomorphic note layout is assigned to a respective said alphanumeric button of said left button set, wherein assigning of each said note of said first note layout to said respective alphanumeric button maintains the inter-button interval pattern of said first isomorphic note-layout;

wherein each said note of said second isomorphic note layout is assigned to a respective said alphanumeric button of said right button set, wherein assigning of each said note of said second note layout to said respective alphanumeric button maintains the inter-button interval pattern of said second isomorphic note-layout;

said keyboard forming a music controller input device such that operation of a said alphanumeric button emits a signal that can be interpreted by a tone generator to mean that said note assigned to said alphanumeric button is to be generated.

In still a further aspect the present invention provides a method of mapping a two dimensional note layout to an alphanumeric keyboard including the steps of:

selecting an isomorphic note layout,

selecting a plurality of keys on said keyboard, and

assigning each musical note in said note layout to a respective said button, such that the arrangement of notes on said keyboard maintains said isomorphic note layout and said keys on said keyboard have a fixed musical interval.

In yet another aspect the present invention provides a system for mapping an isomorphic note layout, said layout including a plurality of notes wherein each said note is assigned to a respective at least one alphanumeric button of an alphanumeric keyboard, said keyboard forming a music controller input device such that operation of a said alphanumeric button is interpreted by a music controller that said note assigned to said alphanumeric button is to be generated, and wherein assigning of said plurality of notes to said respective at least one alphanumeric button maintains the isomorphic pattern such that each adjacent said note assigned to said at least one alphanumeric button on said keyboard has a defined musical interval or pitch difference.

In the preferred embodiment the buttons are labelled and/or coloured to improve usability of the keyboard and to graphically represent the mapping which has been applied.

Ideally the buttons will also be velocity sensitive and/or pressure sensitive to allow the keyboard to capture and transmit such data so as to provide for musical effect.

Ideally the keyboard will detect the pressing of any button combination, without restricting the user to pressing only a few buttons at a time (as is common on current alphanumeric keyboards), or if the number of simultaneously-detectable buttons is limited, this limitation will not interfere with playing of any chord, whether diatonic or non-diatonic.

### BRIEF DESCRIPTION OF THE DRAWINGS

The present invention will now be described, by way of example only, with reference to the accompanying drawings, in which:

FIG. 1 shows the familiar computer keyboard button-arrangement and its standard QWERTY alphanumeric character layout.

FIG. 2a shows a mapping of two octaves of a pitch-based note-layout to the alphanumeric keyboard. This mapping is mirrored in FIG. 2b.

FIG. 3a shows a mapping of two octaves of an interval-based note-layout to the alphanumeric keyboard. This mapping is mirrored in FIG. 3b.

FIG. 4 shows a mapping of four octaves of pitches to the alphanumeric keyboard.

FIG. 5 shows a mapping of four octaves of intervals to the alphanumeric keyboard.

FIG. 6 shows one possible embodiment of the Wicki/Hayden layout.

FIG. 7 shows a mapping of extended tonic solfa interval names in the Wicki/Hayden layout to an alphanumeric keyboard.

### DESCRIPTION OF PREFERRED EMBODIMENT

A “pitch-based” system is one in which pitches or pitch-classes are specified and intervals are derived. For example, Common Western music notation is pitch-based.

An “interval-based” system is one in which intervals are specified and pitches are derived. For example, tonic solfa is interval-based. In an interval-based system, a “reference pitch” is required for the derivation of pitches from intervals. For example, in C Major, the pitch class C is associated with Do, whereas in F Major, F is associated with Do; C and F are reference pitches (if an octave is also specified). The combination of a pitch class and an octave, or of a frequency in cycles per second, fully specifies a reference pitch, which is then associated with the tonic (or with Do by default if no tonic is specified).

In a pitch-based note-layout, the location of a given pitch class (e.g., C) within the layout is the same in all keys, but the harmonic function of that pitch class will change across keys. In an interval-based note-layout, the location of a given interval class (e.g., Do) within the layout is the same in all keys, but its pitch will change across keys.

A “tone generator” is a device for producing musical sounds. A “musical controller” is a device for controlling musical sounds. A music controller emits a stream of music-control signals, in a proprietary format or an industry standard format such as MIDI (Musical Instrument Digital Interface) or OSC (Open Sound Control). That is, a tone generator makes sounds, and a music controller tells a tone generator what sounds to make. The tone generator and music controller serve logically distinct functions, and may be embodied in separate devices or integrated into the same device.

A music controller with an interval-based note-layout may provide means allowing the musician to control the current reference pitch and modify its signals based on the current reference pitch, so that the signals emitted by the controller are pitch-based. Alternatively, a tone generator, receiving interval-based note signals from a musical controller, can combine these interval-based note signals with the current reference pitch to determine the pitches of the notes to be sounded.

SACBA

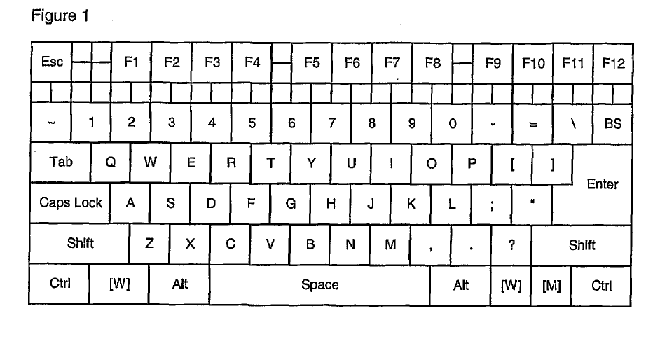

The standard English language QWERTY keyboard's alphanumeric layout and button-arrangement is shown in FIG. 1. The alphanumeric character and function layouts and button-arrangements may vary slightly from this standard depending on manufacturer, geographic region, language, and/or product, without materially affecting the application of the present invention thereto. Hereafter, this button-arrangement and those substantially similar to it will be referred to collectively as the Standard Alphanumeric Computer Buffon Arrangement or SACBA for short.

Wick/Hayden Note Layout

One note-layout that can be mapped to SACBA keyboards is the Wick/Hayden layout. This layout was patented by Wicki in 1896 (CH Patent No. 13329), and again by Hayden in 1986 (GB Patent No. 2131592).

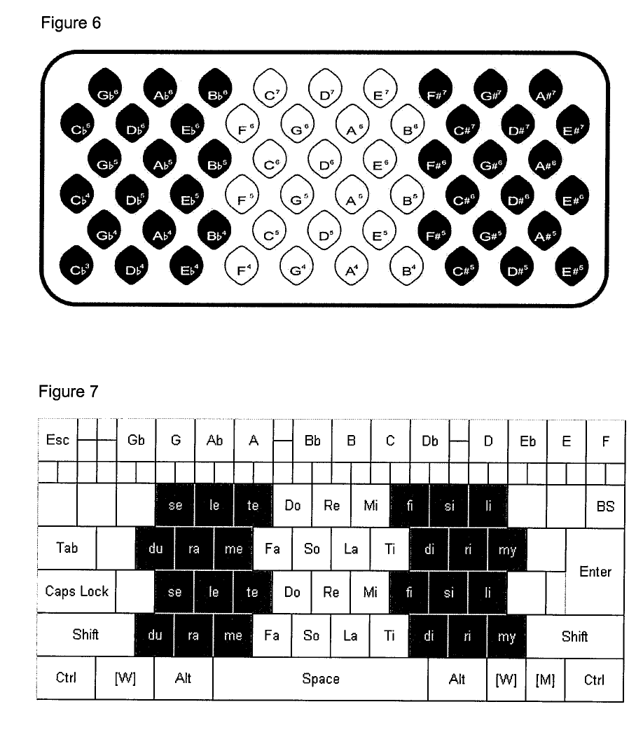

One possible embodiment of the Wicki/Hayden layout is shown in FIG. 6. The Figure shows a two-dimensional, substantially-hexagonal array of notes. The mirror image of this layout, reflected along a vertical plane, is also a Wick/Hayden layout. The layout can be extended or contracted horizontally by adding or removing one or more columns of notes (or portions thereof), or vertically by adding or removing one or more rows of notes (or portions thereof), that fit the pattern of the layout.

The Wicki/Hayden layout is especially interesting because it has the quality of “isomorphism,” from the Greek prefix “iso-” meaning “same” and “morph” meaning “shape”—hence, “same shape.”

In an isomorphic layout, any pair of notes in the same given geometric relationship sounds the same musical interval. Thus any given geometric pattern of intervals between notes—a scale, a chord, a song, whatever—is the same in any key (edge conditions aside). Isomorphic layouts are also known as “tonnetz,” “tone networks,” and “generalized keyboards.” There are many possible isomorphic note-layouts.

A given isomorphic note-layout can be defined by two “adjacency intervals,” H (horizontal) and V (vertical), wherein H is the musical interval between a given note and a rightwardly-horizontally-adjacent note and V is the musical interval between said given note and one upwardly-vertically-adjacent note. (In a hexagonal grid of notes, the vertically-adjacent note is neither directly opposed to, nor adjacent to, said horizontally-adjacent note.) These adjacency intervals, H and V, define the inter-button interval pattern of an isomorphic note-layout.

One possible embodiment of the Wicki/Hayden note-layout is shown in FIG. 6. It can be seen that from any given note in the layout (edge conditions aside), the note that is rightwardly-adjacent is a major second higher in pitch than the starting note. Likewise, from any given note, the note that is up-and-leftwardly adjacent is a perfect fourth higher in pitch than the starting note. That is, in the Wicki-Hayden note-layout, H is a major second and V is a perfect fourth. These two geometrical/musical relationships, applied consistently over the layout, define the inter-button interval pattern of the Wicki/Hayden note-layout.

Alternatively, FIG. 6 can be considered to show a two-dimensional, substantially-hexagonal array of note-controlling buttons to which the Wicki-Hayden layout has been mapped. In some embodiments, this mapping can be used for both the right hand and left hands. In other embodiments, it can be used for the right hand only and its mirror-image used for the left hand, or vice-versa.

Mapping the Wicki/Hayden Layout to SACBA Keyboards

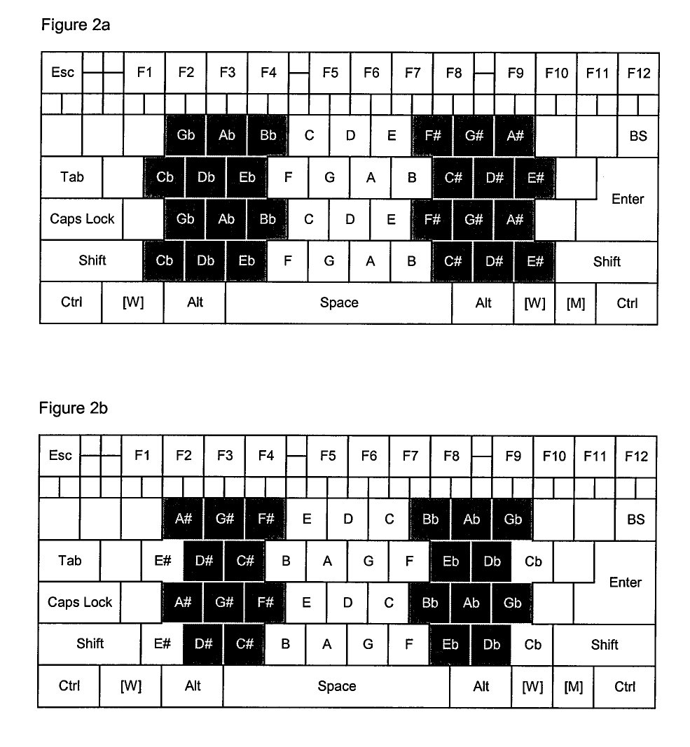

FIG. 2a shows the mapping of the Wicki/Hayden layout to a SACBA keyboard. Of the many possible isomorphic layouts, the Applicants consider that the Wicki/Hayden layout best fits the SCABA button-arrangement.

In one embodiment, the up and down arrow keys (not shown) could shift the pitches of the notes up and down an octave respectively, so octaves are not indicated in FIG. 2a or similar Figures.

FIG. 2b shows a mirror-image of the layout from 2a. This mirrored layout could be useful (for example) if two alphanumeric keyboards were attached to the same computer, allowing the performer to play two alphanumeric keyboards musically at once, providing a four-octave range.

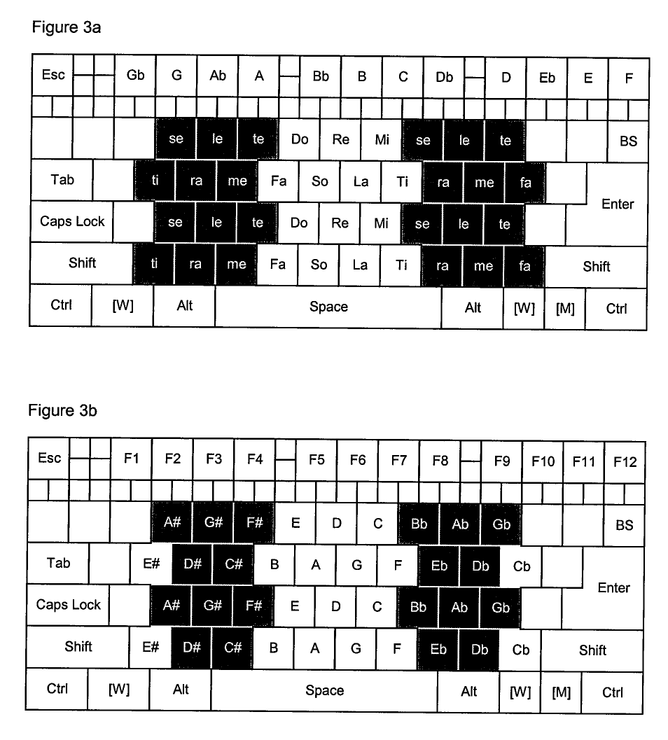

FIG. 3a shows the same arrangement, but using interval names rather than pitch names. The tonic solfa names used in the figure will be familiar to all those versed in the musical arts. Other embodiments could identify the intervals using the numerals 0 through 11, or the North Indian sargam interval names, or other naming systems for the same intervals. All such naming systems will be referred to collectively hereinafter as “tonic solfa.” FIG. 3b shows the mirror image of the arrangement shown in FIG. 3a.

In some embodiments of interval-based mappings, control over the current reference pitch will be provided. In the embodiments shown in FIGS. 3a & 3b, the twelve possible key signatures have been associated with the twelve function keys, allowing the pitch class of the current reference pitch to be selected. Another possible embodiment could use the keyboard's left and right arrow keys (not shown) to shift the current reference pitch down and up a semi-tone respectively, freeing the function keys for other uses. Another possible embodiment could use the keyboard's up and down arrows (not shown) to shift the current reference pitch up down an octave respectively.

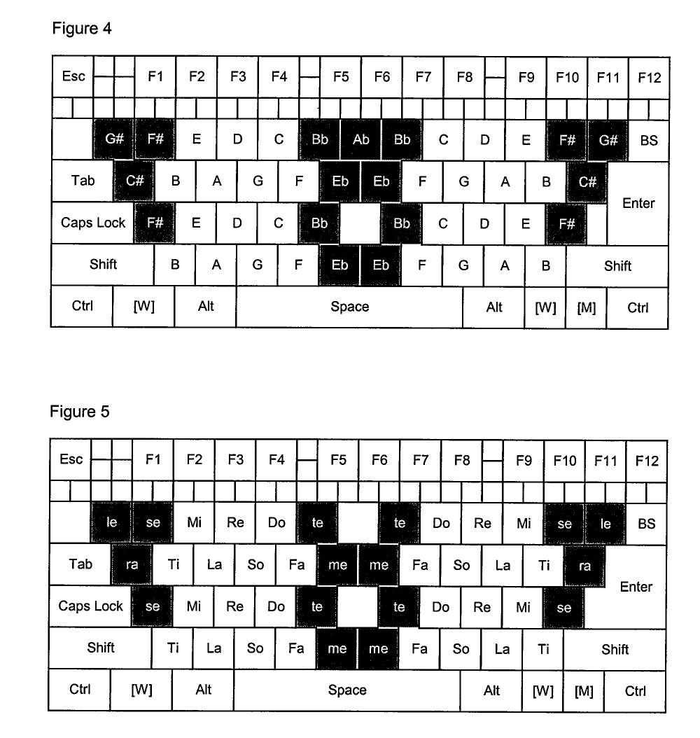

In the modern standard 12-tone equal-temperament (12-tet) tuning, each chromatic note has two names, forming an “enharmonic pair.” Such pairs include F#/Gb, G#/Ab, A#/Bb, etc. It will be observed that in FIGS. 2a, 2b, and 4, each note of an enharmonic pair has its own button. In 12-tet, each of these buttons will sound the same musical tones, so in FIGS. 3a, 3b, and 5, the same interval name is used for both notes of the enharmonic pair. Using the same name for both notes of an enharmonic pair is expected to make teaching and learning 12-tet music easier.

Four-Octave Mapping

If only one button for each of 12-tet's enharmonic pairs of chromatic notes is provided, a four-octave mapping of the Wicki/Hayden layout can be squeezed onto a single SACBA keyboard. In the preferred embodiment of such a four-octave mapping, the octaves on the left would be played by the left hand, while those on the right would be played by the right hand. One such mapping is shown in FIG. 4.

In FIG. 4 the keyboard may be divided substantially in half, with a left hand set and a right hand set. Both the left hand set and right hand set may have the same layout, or alternatively the left hand set could be a mirror image of the right hand set, or be completely different.

Unfortunately, there is not sufficient room for all 12 chromatic notes in such a four-octave mapping. The mapping shown in FIG. 4 contains (in all octaves) C, D, D#/Eb, E, F, F#/Gb, G, A, A#/Bb, and B. However, it only includes C#/Db and G#/Ab in the highest octave of each hand. Note that the button that might contain Ab in the lower octave cannot do so, due to ambiguity over the octave to which it belongs. The four-octave pitch-based mapping shown in FIG. 4 has the same fingering for diatonic sequences and combinations in only some—but not all—keys.

The lack of these notes from some octaves is of less importance in the tonic solfa version of the same mapping, shown in FIG. 5, since diatonic notes are far more common than chromatic notes in popular music, and all diatonic notes are included in the mapping. The absence of some chromatic notes from some octaves would require alterations at performance time—chord inversions and/or melodic changes—that are not ideal but which may not prove to be overly burdensome, either.

In another embodiment the chording hand's set (usually the left hand's set) could be narrower, containing fewer chromatic notes, while the melodic hand's set (usually the right hand's set) could be wider, containing more chromatic notes.

Alternative Tuning Systems

Tuning systems other than 12-tone equal temperament, such as ¼-comma meantone, have been popular at other times and/or in non-Western cultures. Such tuning systems may have different patterns of enharmonic pairs, or no enharmonic pairs at all. For example, in 19-tet, E# is not equal to F, nor is Cb equal to B, as they are in 12-tet. The pitch-named mappings shown in FIGS. 2a, 2b, 3a, and 3b accommodate many of these alternative tunings.

Extended Tonic Solfa Interval Names—My and Du

An extension to traditional tonic solfa names provides similar flexibility across alternative tunings. Traditional tonic solfa encompasses different names for the sharp & flat versions of chromatic notes (Di/Ra, RVMe, etc.), however, it does not provide names for the equivalent of Cb and E# (in C Major)—the intervals “in between” diatonic semi-tone steps—which can be found at the extreme edges of meantone, E# is not equal to F, nor is Cb equal to B, as they are in 12-tet. The pitch-named mappings shown in FIGS. 2a, 2b, 3a, and 3b. The present invention follows the precedent of Isomorphic Solfa Music Notation in calling these intervals My and Du, respectively. An embodiment of the present invention, mapping the extended tonic solfa names of the Wicki/Hayden note-layout, is shown in FIG. 7.

Expressive Controls

On many laptop computers, a touch-sensitive pad is located just below the space bar, conveniently located for the thumbs to touch. The axes of this thumb-pad could be mapped to control musical effects, much as the pitch bend and mod wheels used on a typical piano-keyboard synthesizer. Similarly, the force-sensitive fingertip joystick often located between the home keys on a laptop can serve a similar function, as could an external mouse, track-ball, or standard joystick. One or more joysticks, each sized and positioned for manipulation by a single thumb while playing notes with the fingers of the same hand, could also be provided on a SACBA keyboard. All of these input devices could allow expressive control over the notes selected in accordance with the mapping described herein.

Most high-quality electronic piano keyboards have velocity-sensitive keys. This means that the velocity with which a key is pressed is measured, in addition to the binary on/off status of each key. This is useful in controlling musical expression, specifically the volume (loudness) of each individual note. Some electronic keyboards also include a means of measuring “channel pressure,” that being the current pressure being applied by the fingers to the keyboard at any given time, or even “polyphonic after-touch,” which is a button-by-button measurement of post-strike pressure.

Keyboards used exclusively for alphanumeric data entry do not benefit from support for velocity-sensitivity, channel pressure, or polyphonic after-touch. However, alphanumeric keyboards which are also to be used for entering or controlling musical expression can benefit from the presence of some or all of these features. There are many means of detecting and measuring key velocity, channel pressure, and/or polyphonic after-touch, any of which could be applied to the present invention, as could new methods developed in future. The preferred embodiment includes support for the detection of key velocity at least, with channel pressure and/or polyphonic after-touch being less-critical options.

Colours and Labels

It should be observed that in FIG. 1, the colour of all buttons is identical. This is usually the case with alphanumeric computer keyboards, on which button colour does not usually convey meaning. However, in all the Figures herein that show musical keyboard mappings, colour is used to distinguish between musically-useful subsets of the current-key's chromatic scale's notes (specifically, distinguishing the current key's diatonic notes from its chromatic notes). In an alternative embodiment, each interval class (all Do's, for example) could have a unique colour. In yet another embodiment, each diatonic interval class would have its own unique colour while all chromatic notes would share a single colour.

In addition to coloration, or as an alternative to it, an embodiment of the present invention could label its buttons with interval names in addition to the alphanumeric labels already on such buttons, or in another embodiment supply stickers which the user could apply to the keyboard's buttons in the above patterns.

Ergonomics

It will be noted that the four-octave mappings may be difficult to play on a SACBA keyboard—one's wrists must bend inward at what could be an awkward angle. This twisting is a problem for alphanumeric typing as well. Ergonomic SACBA keyboards exist which mitigate the wrist's twisting by separating and/or rotating the keyboard into two halves. It is therefore desirable, in the preferred embodiment, to use the present invention with such an ergonomic SACBA keyboard.

Chords

Many SACBA keyboards limit the number of buttons which register as being pressed simultaneously. Only the first few pressed will register as being pressed. In the preferred embodiment, the SACBA keyboard has no such limit, or has a limit which does not interfere with chord-playing.

Some Advantages of the Present Invention

One useful advantage of using an interval-based mapping is that the notes of the current key's diatonic scale can always be centred on the keyboard (on Do, Re, Mi, etc.). This can make it easier to teach and learn the relationships among the notes of the diatonic scale (and its notes' chromatic alterations), which are consistent across keys, modes, and tunings. Pitch-names tend to obscure the consistency of these relationships. The diatonic scale is not the only scale of interest, but the most-commonly-used notes of the most-common other scales in tonal music—harmonic, double harmonic, melodic, Neopolitan, etc.,—are also tightly clustered around the central spine of Re-labelled notes

Four-octave interval-based mappings such as the one shown in FIG. 5 fit more octaves of the most important (diatonic) notes onto a SACBA keyboard—regardless of key—than previous pitch-based mappings, such as that shown in FIG. 4.

Interval-based mappings are particularly useful when combined with Isomorphic Solfa Music Notation, which is also interval-based.

Because SACBA keyboards are, by definition, connected to computers, and computer software can facilitate the electronic transposition required by interval-based layouts and notation, the combination of interval-based layouts and SACBA keyboards can be especially advantageous.

1. A system for mapping an interval-based isomorphic note layout to an alphanumeric keyboard, said layout including a plurality of notes wherein each said note is assigned to a respective at least one alphanumeric button of said alphanumeric keyboard, said keyboard forming a music controller input device such that operation of a said alphanumeric button produces a signal that can be interpreted by a tone generator to indicate that said note assigned to said alphanumeric button is to be generated, and wherein assigning of said plurality of notes to said respective at least one alphanumeric button maintains the inter-button interval pattern of said isomorphic note-layout.

2. A system as claimed in claim 1 wherein said layout is a Wicki/Hayden layout.

3.-5. (canceled)

6. A system for mapping a first and second isomorphic note layout to an alphanumeric keyboard, said keyboard including a left button set and a right button set, said left and right button sets each including a plurality of alphanumeric keys, wherein said first note layout is mapped to said left button set, and said second note layout is mapped to said right button set;
wherein each said note of said first isomorphic note layout is assigned to a respective said alphanumeric button of said left button set, wherein assigning of each said note of said first note layout to said respective alphanumeric button maintains the inter-button interval pattern of said first isomorphic note-layout;
wherein each said note of said second isomorphic note layout is assigned to a respective said alphanumeric button of said right button set, wherein assigning of each said note of said second note layout to said respective alphanumeric button maintains the inter-button interval pattern of said second isomorphic note-layout;
said keyboard forming a music controller input device such that operation of a said alphanumeric button produces a signal that can be interpreted by a tone generator to indicate that said note assigned to said alphanumeric button is to be generated.

7. A system as claimed in claim 6 wherein said first and second note layouts are identical.

8. A system as claimed in claim 6 wherein said second note layout is a mirror image of said first note layout.

9.-13. (canceled)

14. A method of mapping a two dimensional note layout to an alphanumeric keyboard including the steps of:
selecting an isomorphic note layout,
selecting a plurality of keys on said keyboard, and
assigning each musical note in said note layout to a respective said button, such that the arrangement of notes on said keyboard maintains the inter-button interval pattern of said isomorphic note-layout.

15. A system for mapping an isomorphic note layout, said layout including a plurality of notes wherein each said note is assigned to a respective at least one button of a data input device, said data input device forming a music controller input device such that operation of a said button is interpreted by a tone generator that said note assigned to said button is to be generated, and wherein assigning of said plurality of notes to said at least one button maintains the inter-button interval pattern of said isomorphic note-layout.

16. A system as claimed in claim 15 wherein said data input device is an alphanumeric keyboard and said button is an alphanumeric button on said keyboard.

17. A system for mapping an isomorphic note layout, said layout including a plurality of notes wherein each said note is assigned to a respective at least one alphanumeric button of an alphanumeric keyboard, said keyboard forming a music controller input device such that operation of a said alphanumeric button producer a signal that can be interpreted by a tone generator to indicate that said note assigned to said alphanumeric button is to be generated, and wherein assigning of said plurality of notes to said respective at least one alphanumeric button maintains the inter-button interval pattern of said isomorphic note-layout.

18. A system for mapping a first and second note layout to an alphanumeric keyboard, said keyboard including a left button set and a right button set, said left and right button sets each including a plurality of alphanumeric buttons, wherein said first note layout is mapped to said left button set, and said second note layout is mapped to said right button set;
said first and second note layouts each including a plurality of notes forming a respective isomorphic arrangement;
wherein each said note of said first note layout is assigned to a respective said alphanumeric button of said left button set, wherein assigning of each said note of said first note layout to said respective alphanumeric button maintains the isomorphic arrangement such that each adjacent note assigned to each respective said alphanumeric key of said left key set on said keyboard has a defined musical interval;
wherein each said note of said second note layout is assigned to a respective said alphanumeric button of said right button set, wherein assigning of each said note of said second note layout to said respective alphanumeric button maintains the isomorphic arrangement such that each adjacent said note assigned to each respective said alphanumeric key on said right key set on said keyboard has a defined musical interval;
said keyboard forming a music controller input device such that operation of a said alphanumeric button is interpreted by a music controller that said note assigned to said alphanumeric button is to be generated.

19. An alphanumeric keyboard wherein an interval-based isomorphic note layout is mapped to said keyboard said layout including a plurality of notes wherein each said note is assigned to a respective at least one alphanumeric button of said keyboard, said keyboard forming a music controller input device such that operation of a said alphanumeric button produces a signal that can be interpreted by a tone generator to indicate that said note assigned to said alphanumeric button is to be generated, and wherein assigning of said plurality of notes to said respective at least one alphanumeric button maintains the inter-button interval pattern of said isomorphic note-layout.

20. A system as claimed in claim 1 wherein said keys are velocity sensitive for musical effect.

21. A system as claimed in claim 1 wherein said keys are pressure sensitive for musical effect.

22. A system as claimed in claim 1 wherein said system can detect simultaneous operation of a plurality of said keys.

23. A system as claimed in claim 1 wherein said alphanumeric keyboard is an ergonomic keyboard.

24. A system as claimed in claim 6 wherein said keys are velocity sensitive for musical effect.

25. A system as claimed in claim 6 wherein the current pressure on the keyboard is measured for musical effect.

26. A system as claimed in claim 6 wherein each said button is individually pressure sensitive for musical effect.

27. A system as claimed in claim 6 wherein said system can detect simultaneous operation of a plurality of said keys.

28. A system as claimed in claim 6 wherein said alphanumeric keyboard is an ergonomic keyboard.
